(19) United States
(12) Patent Application Publication
(10) Pub. No.: US 2013/0205923 A1
(43) Pub. Date: Aug. 15, 2013

(54) MODULE UNIT AND FLUID ANALYSIS UNIT

(71) Applicants: Marko Brammer, Karlsruhe (DE); Timo Mappes, Karlsruhe (DE); Christof Megnin, Speyer (DE)

(72) Inventors: Marko Brammer, Karlsruhe (DE); Timo Mappes, Karlsruhe (DE); Christof Megnin, Speyer (DE)

(21) Appl. No.: 13/590,229

(22) Filed: Aug. 21, 2012

(30) Foreign Application Priority Data
Aug. 24, 2011 (DE) 20 2011 104963.2

(51) Int. Cl. F16L 9/00

(52) U.S. Cl. CPC F16L 9/00
USPC 73/864.81; 138/109

(57) ABSTRACT

A module unit comprises fluid modules with at least one fluid conduit protruding through the module unit, which is formed of conduit portions merging into each other, which traverse the fluid modules and on side faces of the fluid modules open in fluidic interfaces. Two fluid modules each are releasably connected with each other on opposing side faces, whereby the fluidic interfaces are coupled with each other on opposing side faces. On opposing side faces at least one magnetic element each is provided laterally away from the associated conduits portion. The magnetic elements of opposing side faces are located opposing each other and magnetically attract each other.

### RELATED APPLICATION

This application claims priority to German Application No. 20 2011 104 963.2, which was filed Aug. 24, 2011.

### TECHNICAL FIELD

The invention relates to a module unit of fluid modules and a fluid analysis unit.

### BACKGROUND OF THE INVENTION

Module units are known from various fields of application, for example in electropneumatic systems such as valve islands. The module units are composed of different individual modules which are releasably connected with each other, wherein a plurality of supply conduits extend through the module units and supply each individual fluid module, for example, with energy or air. The advantage of such systems is the high flexibility as far as the number and type of fluid modules is concerned, wherein these systems can easily be adapted to individual customer wishes by coupling various individual fluid modules with each other.

What is decisive in such fluid module units is the design of interfaces between the individual fluid modules, so that on the one hand a reliable, for example fluid-tight or low-loss optical connection is ensured at these interfaces, and on the other hand a simple replacement of fluid modules or expansion of the module unit with further or other individual fluid modules is possible at any time.

### SUMMARY OF THE INVENTION

The invention creates a module unit in which the fluid modules can safely and easily be coupled with each other. Furthermore, an improved fluid analysis unit is indicated.

A fluid module unit comprising fluid modules includes at least one fluid conduit extending through the module unit. The fluid conduit is formed of conduit portions merging into each other. The conduit portions traverse the fluid modules and open in fluidic interfaces on side faces of the fluid modules. Two fluid modules each are releasably connected with each other on opposing side faces to couple fluidic interfaces with each other on the opposing side faces. At least one magnetic element each is provided on opposing side faces laterally away from the associated conduit portion. The magnetic elements of opposing side faces are located opposing each other and magnetically attracting each other.

The term “opposing” means “arranged face to face”. The term “opposite faces” or “opposite sides” defines faces or sides which are arranged on reverse faces or sides.

To accomplish the mechanical releasable connection between the fluid modules with magnetic elements is constructively simple, involves little effort, and can be realized very stably. Constructions with latching connections or snap hooks by contrast are known, which above all when connected and released repeatedly can easily be damaged or even break off.

In addition, a desired connecting force between the individual fluid modules is adjustable via a corresponding design of the magnetic elements.

The fluid conduit is suitable for taking up media such as liquids, in particular water, and gases.

In contrast to a solution known in the prior art according to DE 20 2010 001 422 U1, in which the magnetic element annularly surrounds the conduit portion, the magnetic element of the invention is positioned laterally away from the conduit portion.

The magnetic element can be arranged laterally away from the associated conduit portion, so that the medium which is present in the conduit portion does not directly get in contact with the magnetic element, as otherwise a contamination might occur undesirably. Magnetic materials have no high chemical resistance in particular with respect to inorganic media, and with a direct media contact constituents of the magnetic element might undesirably be dissolved in the medium.

The magnetic elements, for example, are formed as plug and socket, in that a magnetic element projects from its side face and protrudes into a recess in the opposing side face of a fluid module. As a result, a double connection is obtained as the plug and socket engage in each other and additionally attract each other due to the magnetic force acting between the same.

The plug can be formed as permanent magnet and the socket is at least partly formed of a magnetically soft material, or vice versa. The plug may have a circular, cylindrical, or cuboid geometry. The socket is formed to be pot-shaped. It can either be completely made of a magnetically soft material, whereby the magnetic force acting between socket and plug advantageously is increased, or only partly made of such a material, for example only the bottom of the socket. In a cylindrical, sleeve-like socket of non-magnetic material, it then results that the magnetic element is disk-shaped. In a disk-shaped magnetic element the separate socket also can be omitted, so that boundary walls of the recess form the socket in the side faces of the fluid modules, which reduces the cost.

It is, however, also possible that the socket or a part thereof is formed as permanent magnet and the plug is formed of magnetically soft material.

Two magnetic elements each are arranged on opposing side faces, wherein per pair of opposing elements one is formed as a plug and one as a socket, and per side face one plug and one socket are present. By using two magnetic elements on one side face, the stability of the connection between the fluid modules is increased on the one hand, and on the other hand an alignment of the fluid modules relative to each other takes place. In cylindrical plugs and sockets, an anti-rotation protection is achieved by the two magnetic elements on one side face.

The module units can be identical, i.e. identical parts.

Opposing side faces may have an identical geometry. This can be realized particularly easily, when the fluid modules have a symmetrical structure, i.e. for example are formed cuboid or cube-shaped. On the side faces of the fluid modules one plug and one socket each are arranged one beside the other at the same height, wherein the plugs are each arranged on the same side on the side face. When connecting opposing side faces of two fluid modules, the side faces fit together like image and negative image, and plugs and sockets each are located opposing each other and engage in each other. This has the advantage that all fluid modules can be manufactured with identical contours and identical construction, which has a favorable effect on the production costs. Except for the interfaces, the side faces preferably are flat surfaces.

Some fluidic interfaces, for example, are formed as recesses in side faces of the fluid modules, wherein the recesses accommodate a sealing element, in order to couple adjacent interfaces. The fluidic interfaces can have an appropriate contour for positioning the sealing element which can be a sealing ring. When connecting adjacent fluid modules with each other, the sealing element is compressed between the two opposing fluidic interfaces so that the interfaces and the conduit are sealed to the outside. However, a separate sealing element also can be provided for each interface, so that between two fluidic interfaces connected with each other, two sealing elements then are located, whereby more tolerances can be compensated.

In general, two sealing elements on top of each other reduce the sealing effect. The advantage, however, is that the sealing elements are firmly installed in the associated interfaces and when releasing and newly connecting the same, attention no longer must be paid to where or where not the sealing elements are installed. This problem chiefly occurs when the number of interfaces per side face is uneven. When there are two interfaces, for example, always one interface per side face can contain a sealing element. When there is only one interface per side face, it is not quite clear during releasing on which side the sealing element belongs.

The module unit can be traversed not only by the fluid conduit, but also by lines, such as optical and/or electric and/or communication lines, which are formed of line portions which traverse the fluid modules and on side faces of the fluid modules open in additional interfaces. These lines, also called additional lines, can be desirable for carrying out measurements of properties of the medium which is contained in the fluid conduit and for evaluating measurement results. It is favorable that when connecting the fluid modules, optical and electric interfaces similarly are releasably connected with each other, as is the case in the fluidic interfaces. This means that when connecting the opposing side faces of the fluid modules, the mechanical connection is effected via the magnetic elements and in doing so all additional interfaces and line portions are connected with each other.

The optical interface is formed as a releasable optical waveguide coupling part with a receptacle for the optical line such as an optical fiber. Optical fibers are connected with each other in a known way. It is common practice to employ optical adhesives or gels.

The optical waveguide coupling part surrounds the optical line in the manner of a sleeve and has a fork-shaped or cone-shaped coupling formation on an end face pointing to the outside, whereby optical lines coupled to each other are also connected mechanically. The optical waveguide coupling part together with the coupling formation wholly or partly protrudes into a recess of the fluid modules.

In a fork-shaped, in particular two-armed coupling formation with two, preferably pointed fork arms located opposing each other in the optical waveguide coupling part, the optical waveguide coupling parts are identical on opposing side faces of the fluid modules and can easily be put together rotated against each other by 90° with respect to the fork arms and can releasably be connected with each other.

A longitudinal sectional plane through the optical waveguide coupling part intersects a longitudinal sectional plane through the two magnetic elements formed as plug and socket in the region of the tips of the two fork arms at an angle of 45°. With this geometry, the side faces of the fluid modules including the optical interfaces are formed identical with their optical waveguide coupling parts, so that when connecting opposing side faces of two fluid modules, the fork arms of the coupling formation engage in each other and the two optical fibers are releasably optically connected with each other.

The optical interface laterally aligns the adjacent fluid modules relative to each other. This has the advantage that the coupling of light into an adjacent fluid module involves an extremely low loss and even in module units with a plurality of adjacent fluid modules light is guided over larger line portions and beyond a plurality of optical interfaces. In addition, the alignment of the fluid modules relative to each other on the interface is provided with the smallest tolerances, whereas the mechanical interfaces with the magnetic elements are designed with a clearance. The stability of the module unit is further increased thereby, and it is prevented that stress loads undesirably occur between the fluid modules. The magnetic elements, which positively engage in each other, thus form a rough centering for the coupled fluid modules.

The electric interfaces are formed as spring contacts. However, other known electric contacting systems, such as plug connections, are also possible.

The fluid modules include interfaces for connecting conduit portions on at least four side faces located opposite each other in pairs, preferably on all side faces. In this way, the module unit can very flexibly be composed of fluid modules. The fluid modules can be mounted one behind the other in a row. A plurality of such rows of fluid modules can be arranged in parallel within one plane. Furthermore, it is possible to arrange several planes of fluid modules one on top of the other. Between opposing side faces of the fluid modules, the various fluidic, optical and electric interfaces arranged there all are connected with each other, whereby conduits and/or lines protruding through the module unit are composed of the respective conduit portions and/or line portions in the fluid modules.

On at least four side faces located opposite each other in pairs, preferably on all side faces, the fluid modules for example include magnetic elements for connection with opposing side faces of further fluid modules. Thus, all opposing fluid modules are mechanically and magnetically connected with each other in the same way on their side faces. As a result, the module unit is a compact, modular and stable system in which fluid modules can easily be replaced at any time or additional fluid modules can be mounted, if required.

The fluidic conduit portions can protrude through the magnetic elements. This embodiment may be used when the medium is an organic fluid or an inert gas. In the region of the magnetic element, the fluid conduit alternatively is separated from the same by a dividing wall, for example by a hose portion, a film or a sealing element.

The invention also provides a fluid analysis unit with an analysis cell and at least one module unit to be coupled to the same, wherein at least one fluid module is releasably connected with corresponding interfaces of the analysis cell.

These and other features of the present invention can be best understood from the following specification and drawings, of which the following is a brief description.

### BRIEF DESCRIPTION OF THE DRAWINGS

FIG. 1 shows a sectional view of a fluid analysis unit according to the invention;

FIG. 2 shows a perspective view of two fluid modules located opposing each other, which can be coupled with each other to form a module unit according to the invention;

FIG. 3 shows a sectional view through a magnetic interface of the fluid modules according to FIG. 2;

FIG. 4 shows a perspective view of a second embodiment of a fluid module with an optical interface for creating another module unit according to the invention;

FIG. 5 shows a perspective view of two optical waveguide coupling parts in the fluid module according to FIG. 4;

FIG. 6 shows a sectional view through two fluid modules located opposing each other according to a further module unit according to the invention;

FIG. 7 shows a perspective top view of a side face of a fluid module according to FIG. 6; and

FIG. 8 shows a sectional view of a further embodiment of a fluid module as part of a module unit according to the invention.

### DETAILED DESCRIPTION

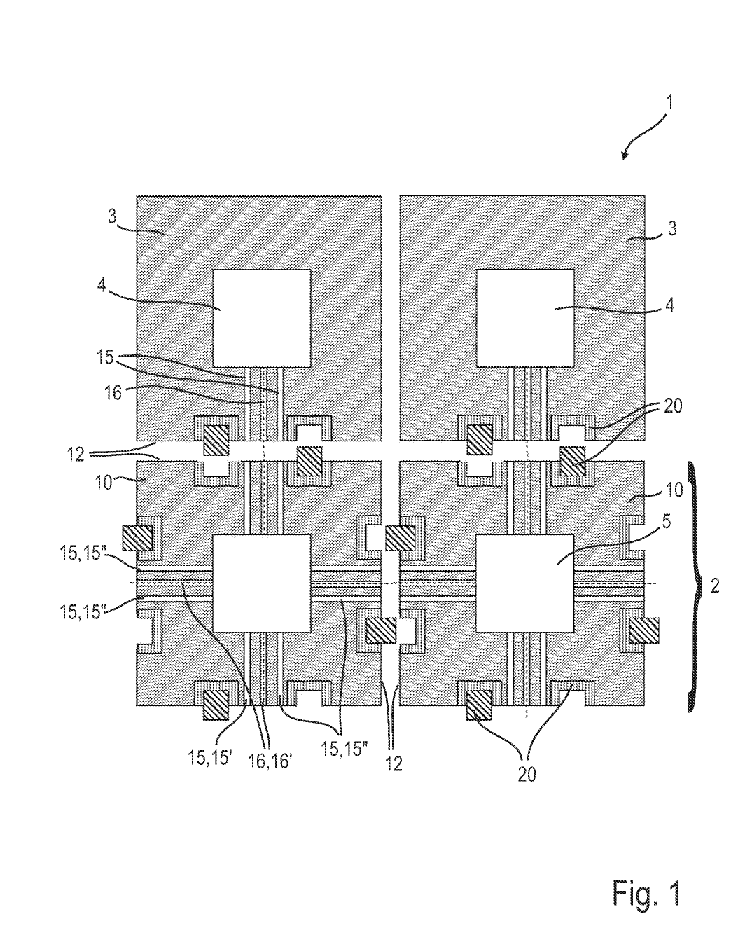

FIG. 1 shows a sectional view of a fluid analysis unit 1 according to the invention, which comprises a module unit 2 and two analysis cells 3 with sensor modules 4 configured as separate components for the diagnosis of medium properties such as pH value, turbidity, concentration, or absorption. The module unit 2 includes two fluid modules 10 configured as separate components. Both the fluid modules 10 are releasably directly connected with each other on opposing side faces 12 by magnetic elements 20 and the analysis cells 3 are connected with the module unit 2, with each analysis cell 3 here being coupled with a fluid module 10.

The module unit 2 can easily be completed by further fluid modules 10 and/or further analysis cells 3.

The module unit 2 is traversed by fluid conduits 15 and lines, subsequently referred to as additional lines 16. These additional lines 16 can be optical, electric and/or pure communication lines. The fluid conduits 15 and the additional lines 16 are composed of conduit portions 15′, 15″ or line portions 16, 16″ in the fluid modules 10, which open on the side faces 12. When connecting fluid modules 10, which is effected by the magnetic elements 20, the adjacent conduit portions 15″, 16′ are coupled with each other for forming the fluid conduits 15 and additional lines 16, respectively.

By a switchable distribution station, for example the horizontal conduit portion 15″ coming from the left in the left fluid module 10 of FIG. 1 can be coupled with the left conduit portion 15 extending downwards from the distribution station 5, or also with the lower horizontal conduit portion 15″ exiting to the right, or with other conduit portions. The same applies for the additional line portions 16′, which can selectively be coupled with each other, which likewise is made possible by the distribution station 5.

The analysis cells 3 likewise include fluid conduits 15 and additional lines 16, which open on the side faces 12 opposing the fluid modules 10. When connecting the analysis cells 3 with the module unit 2, the fluid conduits 15 and additional lines 16 of the fluid modules 10 merge into the fluid conduits 15 and additional lines 16 of the analysis cells 3.

In the analysis cells 3, one fluid conduit 15 each extends towards the sensor module 4 and one back.

To achieve a variable coupling of an arbitrary number of fluid modules with arbitrary analysis cells 3, the fluid modules 10 have the same base surface dimensions as the analysis cells 3.

How the interfaces between the fluid modules 10 and between the analysis cells 3 and fluid modules 10 are designed in detail will be described in the succeeding Figures.

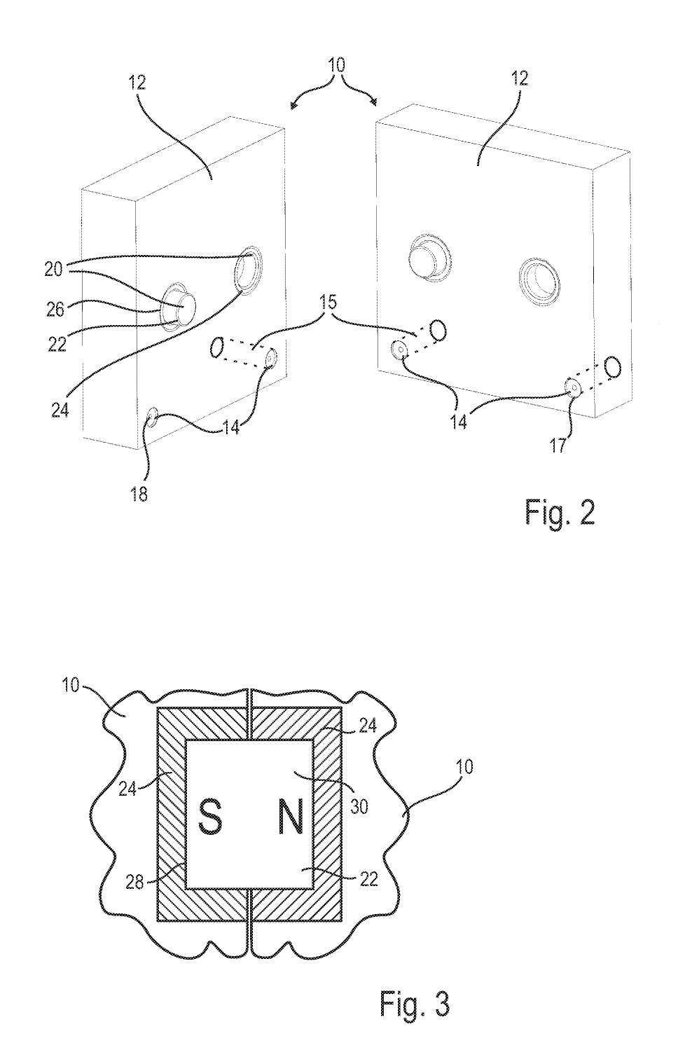

FIG. 2 shows a perspective representation of two separate fluid modules 10 to be coupled with each other to form the module unit 2 with the opposing side faces 12, on which fluidic interfaces 14 are provided. The fluid modules 10 here are not formed as cubes, but in particular as thin cuboids, with side faces vertical to each other. Fluid conduits 15 open in the fluidic interfaces 14, as can also be seen in the succeeding sectional view of FIG. 6 and is described there in detail. These fluid conduits 15 extend through the fluid modules 10 preferably vertically to the side faces 12.

The fluidic interfaces 14 are formed as recesses 17, which each accommodate a sealing element 18 laterally delimiting the respective fluid conduit 15. The recesses 17 here are shown cylindrical, and the sealing element 18 is an O-ring adapted thereto. As compared to the fluid conduits 15, the recesses 17 are laterally expanded, in order to form a shoulder for the O-ring.

The recesses 17 can of course also have another geometry, and the geometry of the sealing element 18 then is correspondingly adapted to the geometry of the recess 17.

On each of the in particular planar side faces 12, two magnetic elements 20 each are arranged laterally away from the fluidic interfaces 14 as connecting the two fluid modules 10, wherein per side face 12 one is formed as plug 22 and one as socket 24. On the side face 12, plug 22 and socket 24 lie one beside the other at the same height and can be coupled with the socket 24 and the plug 22 of the other fluid module.

It is, however, also possible that on the side face 12 of each fluid module 10 only a single magnetic element is arranged. In this embodiment, the magnetic element 20 on the side face 12 of the first fluid module 10 is formed as plug 22, and the magnetic element on the side face 12 of the opposing second fluid module 10 is formed as socket 24.

Alternatively, the magnetic element 20 is not arranged laterally away from the fluid conduit 15, as shown in FIG. 2, but the fluid conduit 15 protrudes through the magnetic element 20, and the fluidic interface 14 then is surrounded by the magnetic element 20. Thus, the mechanical and fluidic interfaces coincide. This embodiment is suitable in particular in applications with chemically non-aggressive media, which flow through the fluid conduits 15, wherein these media do not react with magnetic materials.

In one embodiment, the fluid conduit 15 can be sealed towards the magnetic element 20, for example by a hose portion.

The pot-like sockets 24 are inserted into recesses 26 flush towards the outside, so that the sockets 24 line the recesses 26. The sockets 24 are made of a magnetically soft material.

It is, however, also possible that a socket 24 is formed by the recess 26 and a separate disk arranged there at the bottom of the recess is formed of a magnetically soft material.

The plug 22 is formed in two parts as socket 24 and permanent magnet. The plugs 22 protrude from the side faces 12.

In the embodiment shown in FIG. 2, two identical, pot-like sockets 24 of a magnetically soft material initially are inserted into the two recesses 26, wherein one of the two sockets 24 firmly accommodates the permanent magnet by forming the plug 22 and the other socket 24 releasably accommodates the plug 22 of the opposing module 10, when two modules 10 are connected with each other. In this arrangement, the magnetic force of the plug 22 is amplified advantageously by the socket 24 surrounding the same in the plug.

On at least four side faces located opposite each other in pairs, preferably on all side faces. the fluid modules include at least one of interfaces and additional interfaces for connecting conduits and line portions, respectively

All side faces 12 of all fluid modules 10 advantageously have an identical geometry with identical contours. In FIG. 2, the plugs 22 each are arranged on the left side and the sockets 24 on the right side.

The permanent magnet is shown cylindrical in FIG. 2. It can of course also have another geometry, for example be formed cuboid.

FIG. 3 shows a sectional view through two magnetic interfaces connected with each other. In the two opposing modules 10, one magnetic element 20 each is arranged. Two sockets 24 of a magnetically soft material, which preferably are formed pot-like, are located opposing each other. One of the two sockets 24 firmly accommodates the permanent magnet by forming the plug 22, wherein the permanent magnet partly protrudes beyond the socket 24 with an end 30. At the bottom 28 of the socket 24, the permanent magnet preferably is glued into the socket 24 on its side opposing the end 30. With its protruding end 30, the plug 22 engages into the second opposing socket 24. Between the plug 22 and the socket 24 a magnetic force acts, so that between the same both a mechanical and a magnetic connection exists.

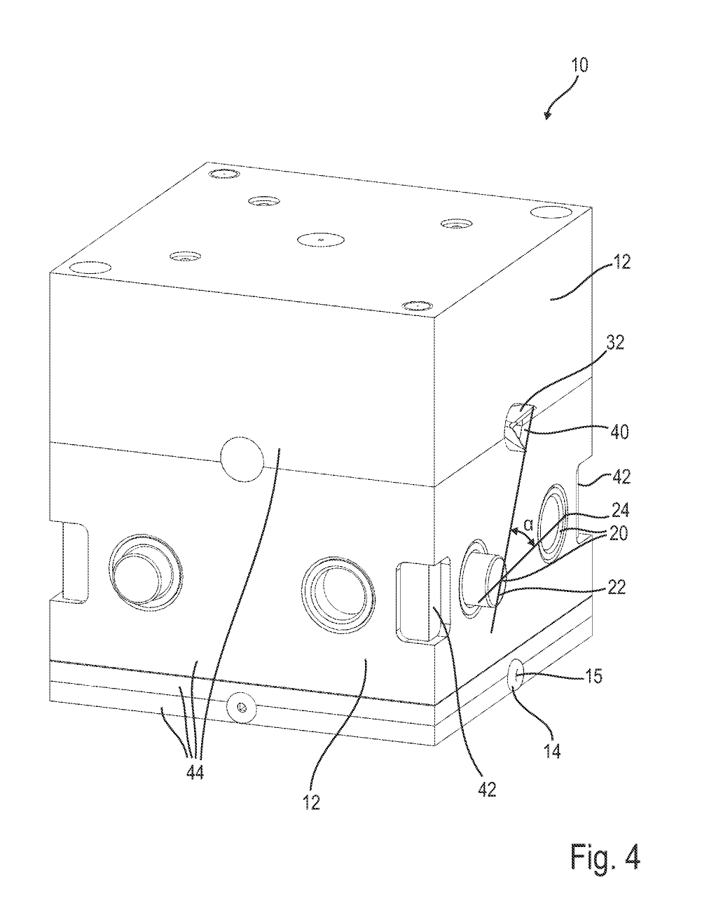

FIG. 4 shows a perspective view of a second embodiment of the fluid module 10 with the fluidic interfaces 14, the magnetic elements 20, which are formed as plug 22 and socket 24, and an optical interface 32, referred to as an additional interface. In this embodiment, one plug 22 and one socket 24 each are arranged one beside the other on two side faces 12. All magnetic elements 20 lie in one plane.

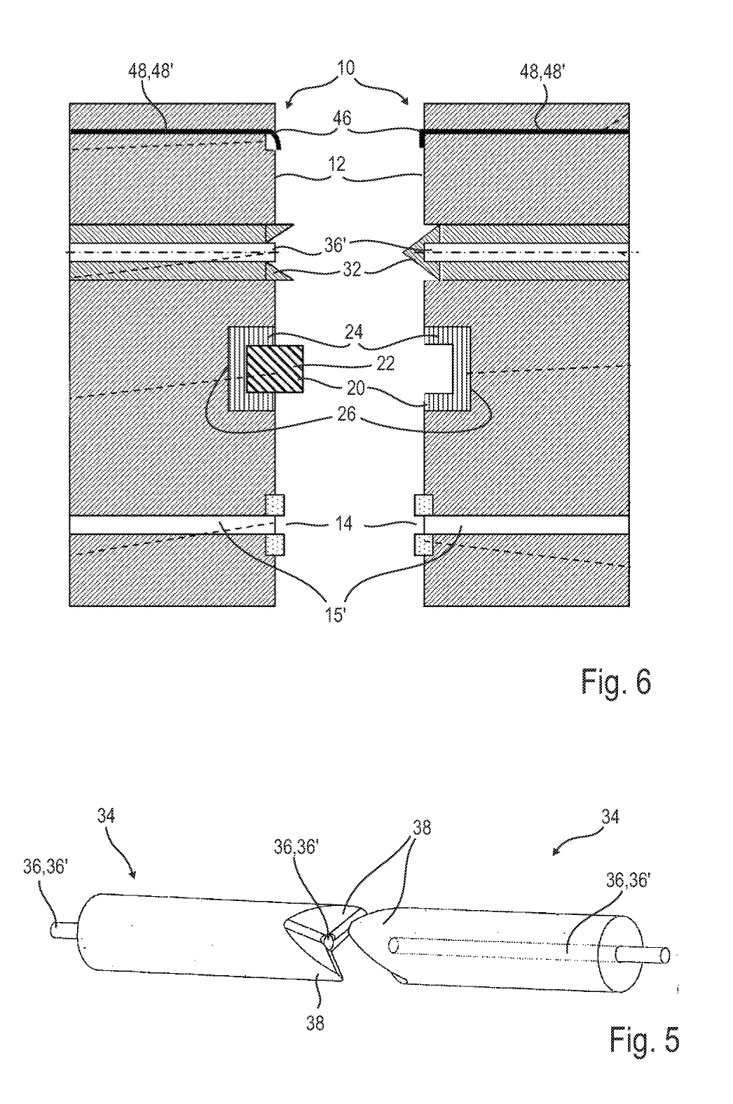

The optical interface 32 is formed as a releasable optical waveguide coupling part 34 with a receptacle for the optical line 36 such as, for example, an optical fiber (FIG. 5).

The optical waveguide coupling part 34 surrounds the optical line 36 in the manner of a sleeve, and on an end face pointing to the outside has a fork-shaped coupling formation with two pointed fork arms 38. The optical waveguide coupling part 34 together with the coupling formation wholly or partly protrudes into a recess 40 of the fluid modules 10.

The two optical waveguide coupling parts 34, likewise located opposing each other in two opposing fluid modules 10, are identically designed and are connected with each other by the optical lines rotated against each other by 90° around longitudinal axes, wherein the fork arms 38 engage in each other and the optical lines 36 of the two fluid modules 10 are releasably connected with each other.

In the embodiment corresponding to FIG. 4, a longitudinal sectional plane through the optical waveguide coupling part 34 intersects a longitudinal sectional plane through the two magnetic elements 20 formed as plug 22 and socket 24 in the region of the tips of the two fork arms 38 at an angle α of 45°. With this geometry, the side faces 12 of the fluid modules 10 including the optical interfaces 32 are formed identical with their optical waveguide coupling parts 34, so that when connecting opposing side faces 12 of two fluid modules 10, the fork arms 38 of the coupling formation engage in each other and the two optical fibers are releasably optically connected with each other.

The optical interface 32 even laterally aligns the adjacent fluid modules 10 relative to each other. This has the advantage that the coupling of light into an adjacent fluid module 10 involves an extremely low loss, so that even in module units with a plurality of adjacent fluid modules light is guided over larger line portions and beyond a plurality of optical interfaces.

In the plane in which the magnetic elements 20 are located, recessed grips 42 are arranged in regions where two side faces 12 each merge into each other, which provides for easily releasing two fluid modules 10 connected with each other by pulling them apart against the acting magnetic force.

Each fluid module 10 is composed of plates 44 arranged one on top of the other in a layered construction. Contours for the fluid conduits 15 and additional lines 36, which protrude through the fluid modules 10, each are half molded into successive plates 44 located opposing each other.

The plates 44 for example are made by injection molding in plastics technology or by a machining manufacturing method out of metal. The plates 44 are connected with each other in a known way, for example screwed together or in the case of plastics also manufactured by bonding methods or laser beam welding or ultrasonic welding.

It is, however, also possible to design the conduit and line contours each in one plate 44 and cover the same with a succeeding planar plate.

FIG. 6 shows a sectional view through two opposing fluid modules 10, in which a plurality of interfaces are pushed into the sectional plane. On the side faces 12 the recesses 26 are arranged, which accommodate the magnetic elements 20 which are formed as plug 22 and socket 24. Fluid conduit portions 15′ extend in the fluid modules 10 and open in the fluidic interfaces 14 on the side faces 12. In assembled fluid modules 10, the fluid conduit portions 15′ put together form the fluid conduit 15 in a module unit.

The fluid modules 10 also are traversed by the optical lines 36, which on the side faces 12 open in the opposing optical interfaces 32. These additional lines 36 also are composed of line portions 36′ in the fluid modules 10.

The fluid modules 10 optionally are traversed by electric lines 48, which on the side faces 12 of the fluid modules 10 open in electric interfaces 46 (also referred to as additional interface), in order to couple the associated line portions 48′. The electric interfaces 46 are formed as spring contacts or plug contacts.

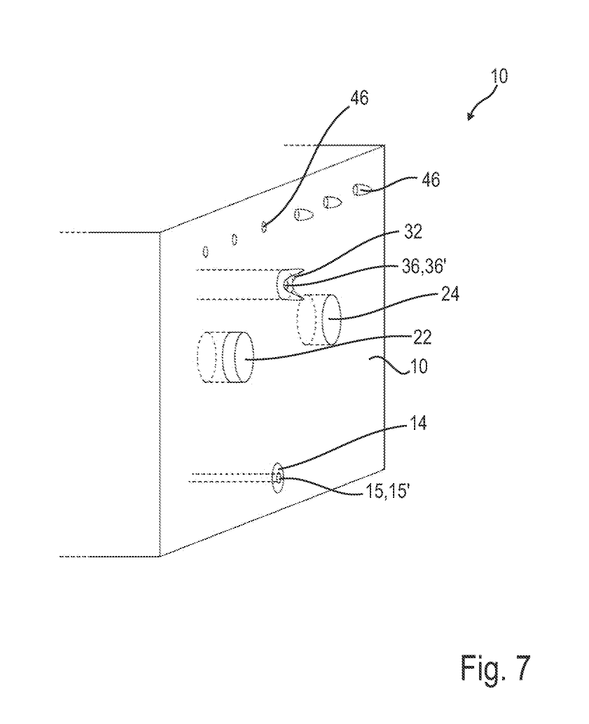

FIG. 7 shows a perspective top view of a side face 12 of a fluid module 10 similar to FIG. 6. There are provided several electric interfaces 46, which are configured as pins and sockets.

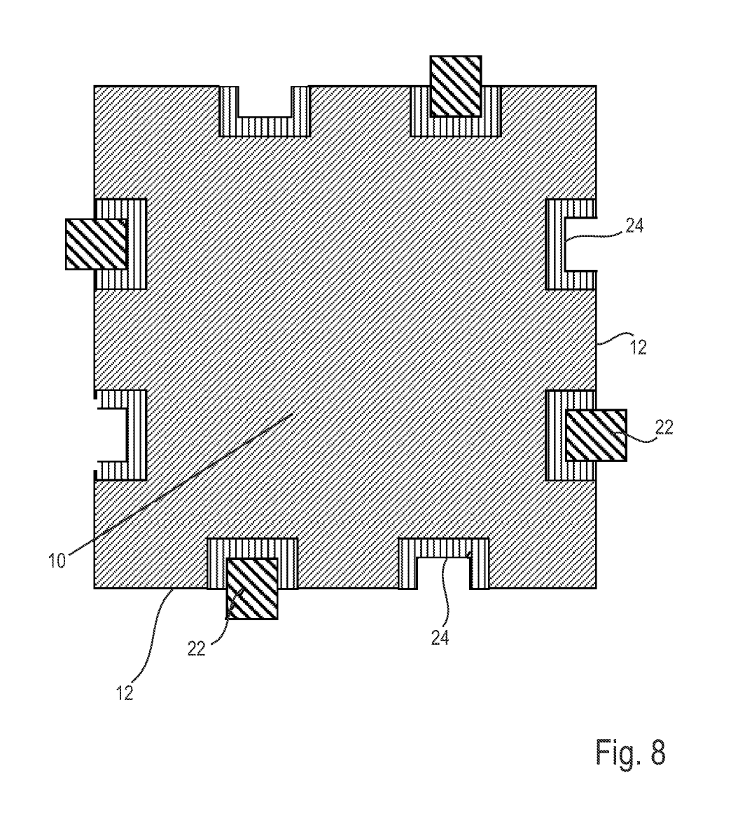

FIG. 8 shows a sectional view of a further embodiment of a fluid module 10, wherein in the sectional plane magnetic plugs 22 and sockets 24 are arranged on each side face 12. Hence, fluid modules 10 can be connected to a module unit 2 in one plane in all directions in space.

Although an embodiment of this invention has been disclosed, a worker of ordinary skill in this art would recognize that certain modifications would come within the scope of this invention. For that reason, the following claims should be studied to determine the true scope and content of this invention.

1. A module unit of fluid modules comprising:
at least one fluid conduit extending through the module unit, the fluid conduit being formed of conduit portions merging into each other, the conduit portions traversing the fluid modules and opening in fluidic interfaces on side faces of the fluid modules, wherein two fluid modules each are releasably connected with each other on opposing side faces to couple fluidic interfaces with each other on the opposing side faces, wherein at least one magnetic element each is provided on opposing side faces laterally away from the associated conduit portion, and the magnetic elements of opposing side faces being located opposing each other and magnetically attracting each other.

2. The module unit according to claim 1, wherein the magnetic elements are formed as a plug and a socket, and wherein one magnetic element projects from an associated side face and protrudes into a recess in the opposing side face.

3. The module unit according to claim 2, wherein one of the socket or the plug is formed as a permanent magnet and the other of the socket or the plug is at least partly formed of a magnetically soft material.

4. The module unit according to claim 1, wherein two magnetic elements each are arranged on opposing side faces, and wherein per pair of opposing magnetic elements one is formed as a plug and one as a socket, and per side face one plug and one socket are present.

5. The module unit according to claim 4, wherein opposing side faces have an identical geometry.

6. The module unit according to claim 1, wherein fluidic interfaces are formed as recesses in side faces of the module unit, the recesses accommodating a sealing element coupling adjacent fluidic interfaces.

7. The module unit according to claim 1, wherein the module unit is traversed by at least one of optical, electric and communication lines, which are formed of line portions, which traverse the fluid modules, and which on side faces of the fluid modules open in additional interfaces.

8. The module unit according to claim 7, wherein an optical interface is formed as a releasable optical waveguide coupling part with a receptacle for an optical fiber.

9. The module unit according to claim 8, wherein the optical waveguide coupling part surrounds the optical line in the manner of a sleeve and on an end face pointing to the outside has one of a fork-shaped and cone-shaped coupling formation.

10. The module unit according to claim 7, wherein an optical interface laterally aligns adjacent fluid modules relative to each other.

11. The module unit according to claim 7, wherein electric interfaces are formed as spring contacts.

12. The module unit according to claim 1, wherein one of the two fluid modules is formed as cuboid-shaped and the other of the two fluid modules is formed as cube-shaped.

13. The module unit according to claim 12, wherein on at least four side faces located opposite each other in pairs, the fluid modules include at least one of interfaces and additional interfaces for connecting conduits and line portions, respectively.

14. The module unit according to claim 12, wherein on at least four side faces located opposite each other in pairs, the fluid modules include magnetic elements for connecting opposing side faces of further fluid modules.

15. The module unit according to claim 1, wherein the fluid modules are composed of plates, wherein recesses are formed in at least one plate for forming or accommodating at least one of conduit portions and line portions.

16. A fluid analysis unit, comprising:
an analysis cell and at least one module unit to be coupled to the analysis cell, wherein the module unit comprises at least one fluid conduit extending through the module unit, the fluid conduit being formed of conduit portions merging into each other, the conduit portions traversing the fluid modules and opening in fluidic interfaces on side faces of the fluid modules, wherein two fluid modules each are releasably connected with each other on opposing side faces to couple fluidic interfaces with each other on the opposing side faces, wherein at least one magnetic element each is provided on opposing side faces laterally away from the associated conduit portion, and the magnetic elements of opposing side faces being located opposing each other and magnetically attracting each other; and
wherein at least one fluid module is releasably connected with corresponding interfaces of the analysis cell.
